(19) United States
(12) Patent Application Publication
(10) Pub. No.: US 2012/0039261 A1
(43) Pub. Date: Feb. 16, 2012

(54) CQI Reporting of TD-SCDMA Multiple USIM Mobile Terminal During HSDPA Operation

(76) Inventors: Tom Chin, San Diego, CA (US); Guangming Shi, San Diego, CA (US); Kuo-Chun Lee, San Diego, CA (US)

(21) Appl. No.: 12/855,508

(22) Filed: Aug. 12, 2010

(51) Int. Cl. H04W 72/12

(52) U.S. Cl. 370/329

(57) ABSTRACT

Certain aspects of the present disclosure provide techniques and apparatus for Channel Quality Information (CQI) reporting of a Time Division-Synchronous Code Division Multiple Access (TD-SCDMA) multiple Universal Subscriber Identity Module (USIM) mobile terminal during a High Speed Downlink Packet Data (HSDPA) operation. For certain aspects, a method of wireless communication generally includes reporting CQI for a first call with a first subscriber identity and receiving scheduling information for at least the first call with the first subscriber identity and a second call with a second subscriber identity, wherein the scheduling information for both the first and second calls are based on the CQI reported for the first call.

### BACKGROUND

1. Field

Certain aspects of the present disclosure relate generally to wireless communication systems, and more particularly, to techniques for Channel Quality Information (CQI) reporting of a Time Division-Synchronous Code Division Multiple Access (TD-SCDMA) multiple Universal Subscriber Identity Module (USIM) mobile terminal during a High Speed Downlink Packet Data (HSDPA) operation.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UTMS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, in certain locations, TD-SCDMA is being pursued as the underlying air interface in the UTRAN architecture with its existing GSM infrastructure as the core network. The UMTS also supports enhanced 3G data communications protocols, such as High Speed Downlink Packet Data (HSDPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

### SUMMARY

In an aspect of the disclosure, a method for wireless communication is provided. The method generally includes reporting channel quality information (CQI) for a first call with a first subscriber identity and receiving scheduling information for at least the first call with the first subscriber identity and a second call with a second subscriber identity, wherein the scheduling information for both the first and second calls are based on the CQI reported for the first call.

In an aspect of the disclosure, an apparatus for wireless communication is provided. The apparatus generally includes means for reporting channel quality information (CQI) for a first call with a first subscriber identity and means for receiving scheduling information for at least the first call with the first subscriber identity and a second call with a second subscriber identity, wherein the scheduling information for both the first and second calls are based on the CQI reported for the first call.

In an aspect of the disclosure, an apparatus for wireless communication is provided. The apparatus generally includes at least one processor and a memory coupled to the at least one processor. The at least one processor is typically configured to report channel quality information (CQI) for a first call with a first subscriber identity and receive scheduling information for at least the first call with the first subscriber identity and a second call with a second subscriber identity, wherein the scheduling information for both the first and second calls are based on the CQI reported for the first call.

In an aspect of the disclosure, a computer-program product is provided. The computer-program product generally includes a computer-readable medium having code for reporting channel quality information (CQI) for a first call with a first subscriber identity and receiving scheduling information for at least the first call with the first subscriber identity and a second call with a second subscriber identity, wherein the scheduling information for both the first and second calls are based on the CQI reported for the first call.

In an aspect of the disclosure, a method for wireless communication is provided. The method generally includes receiving channel quality information (CQI) reported for a first call with a first subscriber identity of a user equipment (UE) and transmitting a first data transmission to the UE during a second call with a second subscriber identity of the UE, wherein one or more parameters of the first data transmission are dependent on the CQI reported for the first call.

In an aspect of the disclosure, an apparatus for wireless communication is provided. The apparatus generally includes means for receiving channel quality information (CQI) reported for a first call with a first subscriber identity of a user equipment (UE) and means for transmitting a first data transmission to the UE during a second call with a second subscriber identity of the UE, wherein one or more parameters of the first data transmission are dependent on the CQI reported for the first call.

In an aspect of the disclosure, an apparatus for wireless communication is provided. The apparatus generally includes at least one processor and a memory coupled to the at least one processor. The at least one processor is typically configured to receive channel quality information (CQI) reported for a first call with a first subscriber identity of a user equipment (UE) and transmit a first data transmission to the UE during a second call with a second subscriber identity of the UE, wherein one or more parameters of the first data transmission are dependent on the CQI reported for the first call.

In an aspect of the disclosure, a computer-program product is provided. The computer-program product generally includes a computer-readable medium having code for receiving channel quality information (CQI) reported for a first call with a first subscriber identity of a user equipment (UE) and transmitting a first data transmission to the UE during a second call with a second subscriber identity of the UE, wherein one or more parameters of the first data transmission are dependent on the CQI reported for the first call.

### BRIEF DESCRIPTION OF THE DRAWINGS

FIG. 1 is a block diagram conceptually illustrating an example of a telecommunications system, in accordance with certain aspects of the present disclosure.

FIG. 2 is a block diagram conceptually illustrating an example of a frame structure in a telecommunications system, in accordance with certain aspects of the present disclosure.

FIG. 3 is a block diagram conceptually illustrating an example of a Node B in communication with a UE in a telecommunications system, in accordance with certain aspects of the present disclosure.

FIG. 4 illustrates three physical channels that may be required in a TD-SCDMA High Speed Downlink Packet Data (HSDPA) system, in accordance with certain aspects of the present disclosure.

FIG. 5 illustrates example operations for receiving scheduling information for multiple calls of a Time Division-Synchronous Code Division Multiple Access (TD-SCDMA) multiple Universal Subscriber Identity Module (USIM) mobile terminal based on Channel Quality Information (CQI) reported for a call, in accordance with certain aspects of the present disclosure.

FIG. 6 illustrates example operations for transmitting a data transmission to a User Equipment (UE) during a second call with a second subscriber identity, wherein one or more parameters of the data transmission are dependent on CQI reported for a first call with a first subscriber identity, in accordance with certain aspects of the present disclosure.

FIG. 7 illustrates the sharing of CQI information from multiple HSDPA calls, in accordance with certain aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

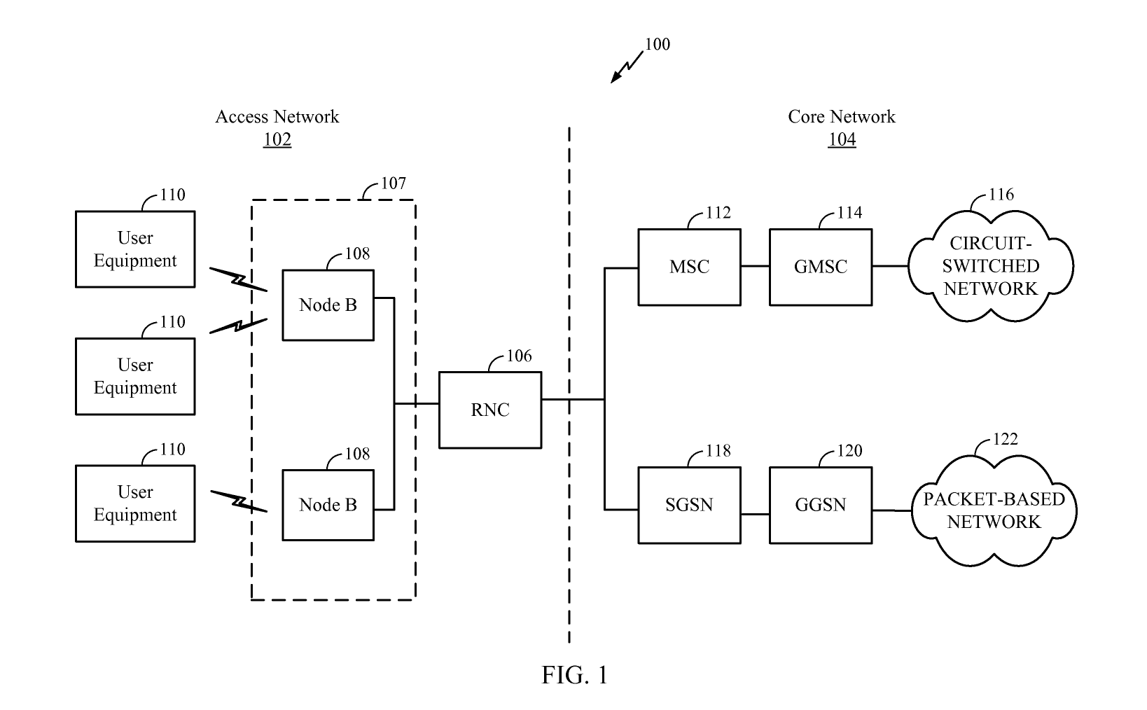

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two Node Bs 108 are shown; however, the RNS 107 may include any number of wireless Node Bs. The Node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the Node Bs 108. The downlink (DL), also called the forward link, refers to the communication link from a Node B to a UE, and the uplink (UL), also called the reverse link, refers to the communication link from a UE to a Node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the location of the UE and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a Node B 108 and a UE 110, but divides uplink and downlink transmissions into different time slots in the carrier.

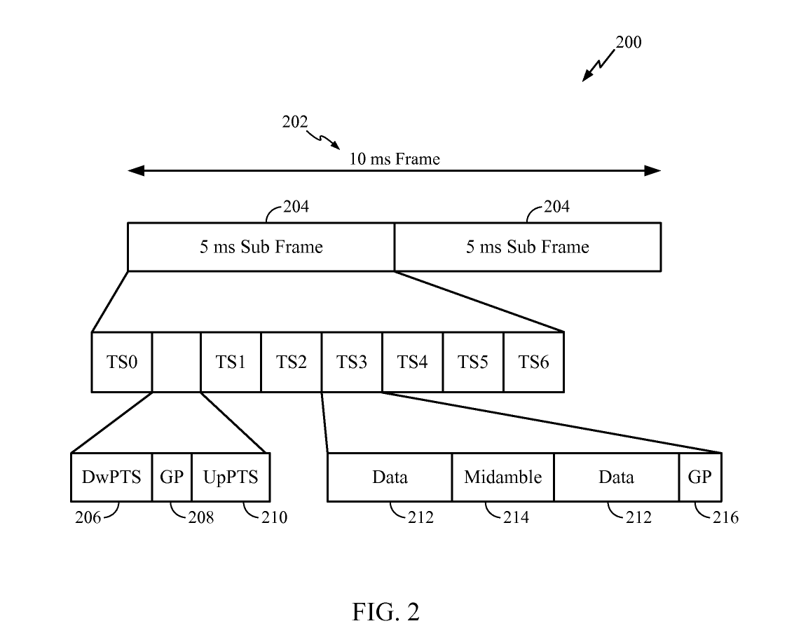

FIG. 2 shows a frame structure 200 for a TD-SCDMA carrier. The TD-SCDMA carrier, as illustrated, has a frame 202 that is 10 ms in length. The frame 202 has two 5 ms subframes 204, and each of the subframes 204 includes seven time slots, TS0 through TS6. The seven time slots may be used for regular traffic and signaling. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. DwPTS may be used to transmit DwPCH (Downlink Pilot Channel), which is for transmitting the pilot signal for the cell. The UpPCH may be used for the UE to perform initial random access procedure and UL synchronization in handover.

Each time slot, TS0-TS6, may allow data transmission multiplexed on a maximum of 16 code channels. Data transmission on a code channel includes two data portions 212 separated by a midamble 214 and followed by a guard period (GP) 216. The midamble 214 may be used for features, such as channel estimation, while the GP 216 may be used to avoid inter-burst interference.

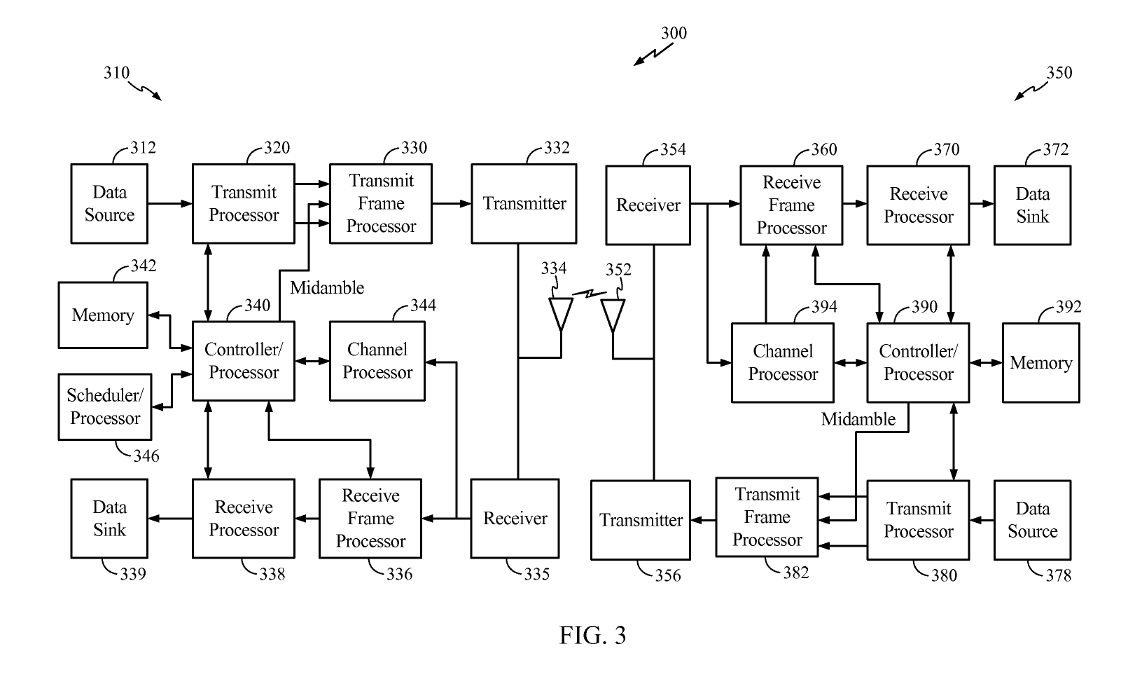

FIG. 3 is a block diagram of a Node B 310 in communication with a UE 350 in a RAN 300, where the RAN 300 may be the RAN 102 in FIG. 1, the Node B 310 may be the Node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the Node B 310. More specifically, the receive processor 370 descrambles and de-spreads the symbols, and then determines the most likely signal constellation points transmitted by the Node B 310 based on the modulation scheme. These soft decisions may be based on channel estimates computed by the channel processor 394. The soft decisions are then decoded and de-interleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the Node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the Node B 310 or from feedback contained in the midamble transmitted by the Node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the Node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the Node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the Node B 310 and the UE 350, respectively. A scheduler/processor 346 at the Node B 310 may be used to allocate resources to the UEs and schedule downlink and/or uplink transmissions for the UEs.

### CQI Reporting of TD-SCDMA Multiple USIM Mobile Terminal During HSDPA Operation

TD-SCDMA (Time Division Synchronous Code Division Multiple Access) is based on time division and code division in order to allow multiple UEs (User Equipments) to share a same radio bandwidth on a particular frequency channel. The downlink and uplink transmissions share the same bandwidth in different time slots (TSs). In each time slot, there are multiple code channels. As discussed in the above paragraphs, in a typical TD-SCDMA frame, one downlink (DL) TS0 is followed by three uplink (UL) TS1˜TS3, and followed by three DL TS4˜TS6. Between TS0 and TS1, there are Downlink Pilot Time Slot (DwPTS) and Uplink Pilot Time Slot (UpPTS), separated by the gap. DwPTS may be used to transmit DwPCH (Downlink Pilot Channel), and UpPTS may be used to transmit UpPCH (Uplink Pilot Channel).

Mobile phones with multiple USIMs (Universal Subscriber Identity Modules) are fairly popular. For example, a mobile phone may have dual USIMs enabling a user to make/receive phone calls in different numbers. Typically, each USIM has a unique IMSI (International Mobile Subscriber Identity).

The dual USIM phones may be standby dual-USIM phones or active dual-USIM phones. Standby dual-SIM phones allow the phone to switch from one USIM to the other as required but do not allow both USIMs to be active at the same time. Active dual-USIM phones allow both USIMs to be active at the same time.

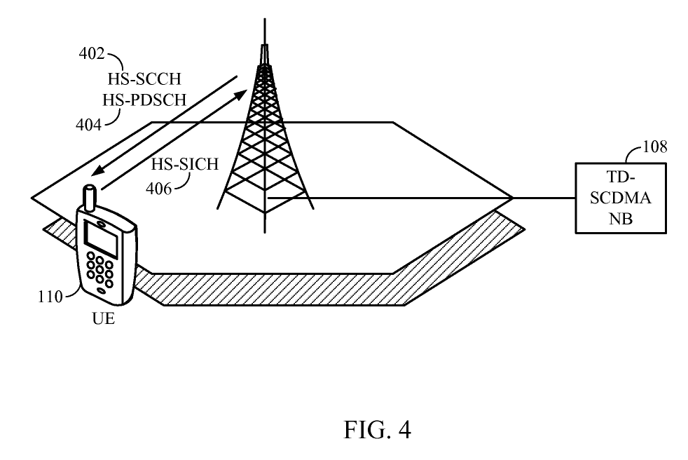

FIG. 4 illustrates three physical channels that may be required in a TD-SCDMA High Speed Downlink Packet Data (HSDPA) system. A High-Speed Shared Control Channel (HS-SCCH) 402 may carry a modulation and coding scheme (MCS) for the data burst in a High-Speed Physical Downlink Shared Channel (HS-PDSCH) 404. Further, HS-SCCH 402 may carry a channelization code and time slot information for the data burst in HS-PDSCH 404. In addition, HS-SCCH 402 may carry UE identity to indicate which UE should receive the data burst allocation. HS-PDSCH 404 may carry the user data burst allocated by HS-SCCH 402. A High-Speed Shared Information Channel (HS-SICH) 406 may carry channel quality information (CQI) comprising RTBS (Recommended Transport Block Size) and RMF (Recommended Modulation Format). Further, HS-SICH 406 may carry a Hybrid Automatic Repeat Request Acknowledgment/Negative Acknowledgment (HARQ ACK/NACK) of the HS-PDSCH transmission 404.

The three physical channels described above may be shared. The UE 110 may continue to monitor HS-SCCH 402. If there is a data transmission, the UE that is to receive the data burst allocation may be indicated by HS-SCCH 402 and, therefore, the indicated UE may receive data on the HS-PDSCH 404 and use the HS-SICH 406 to send HARQ ACK/NACK. Along with HARQ ACK/NACK, the UE may report the CQI that may be used by the Node B 108 to schedule and decide the MCS of subsequent data transmission (e.g., scheduling information).

However, in TD-SCDMA, CQI may be reported by a UE 110 only when there is a data transmission on the HS-PDSCH 404. Therefore, the Node B 108 may not receive CQI from the UE 110 on a frequent or periodic basis.

In certain locations, a mobile phone may have more than one USIM and therefore the user may make a phone call in different phone numbers. Each USIM may have a unique IMSI (International Mobile Subscriber Identity). If these multiple USIMs have already had HSDPA call being established, then each call may monitor the HS-SCCH and wait for receiving data. For some embodiments of the present disclosure, a new enhancement may allow for a more efficient CQI reporting process in HSDPA, as will be described further.

For some embodiments, the Node B 108 may use the CQI across multiple HSDPA calls of multiple USIMs to schedule and decide MCS of the data transmission. These multiple HSDPA calls may have the same physical channel condition as they belong to the same UE 110. Therefore, the CQI from multiple HSDPA calls may be shared.

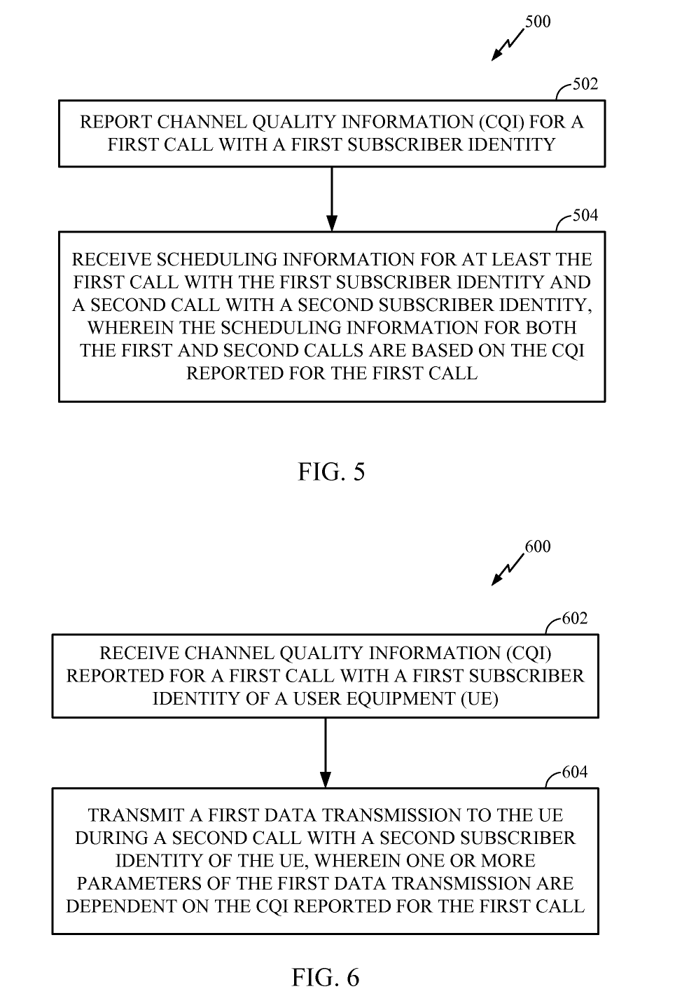

FIG. 5 illustrates example operations 500 that may be performed, for example, by a UE 110, in accordance with certain aspects set for herein. At 502, the UE 110 may report channel quality information (CQI) for a first call with a first subscriber identity. At 504, the UE 110 may receive scheduling information for at least the first call with the first subscriber identity and a second call with a second subscriber identity, wherein the scheduling information for both the first and second calls are based on the CQI reported for the first call.

FIG. 6 illustrates example operations 600 that may be performed, for example, by a Node B 108, in accordance with certain aspects set for herein. At 602, the Node B 108 may receive channel quality information (CQI) reported for a first call with a first subscriber identity of a UE 110. At 604, the Node B 108 may transmit a first data transmission to the UE 110 during a second call with a second subscriber identity of the UE 110, wherein one or more parameters of the first data transmission are dependent on the CQI reported for the first call.

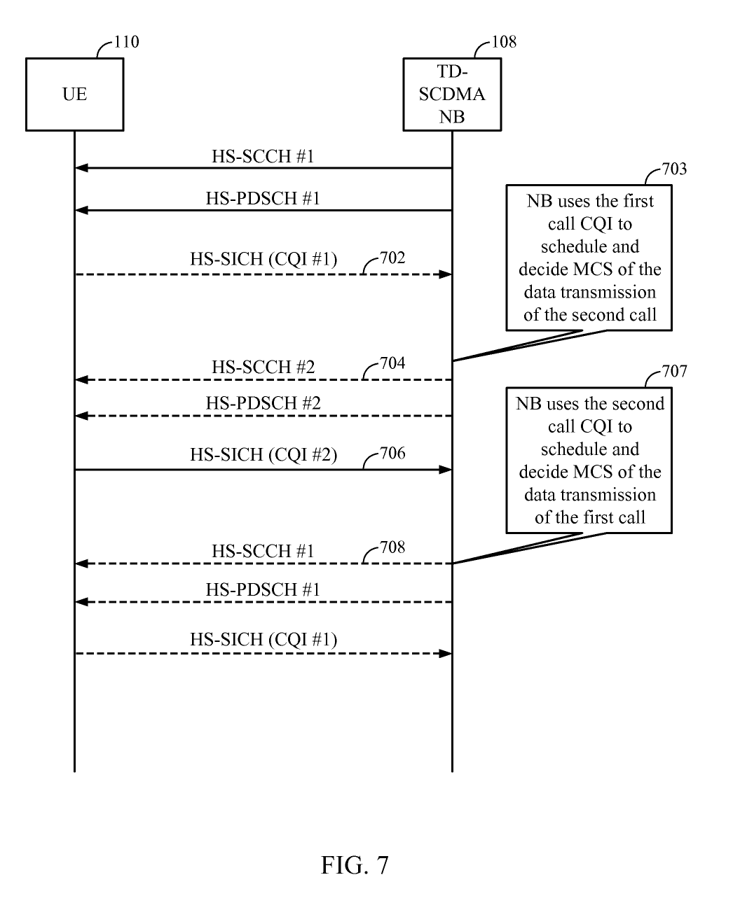

FIG. 7 illustrates the sharing of CQI information from multiple HSDPA calls, in accordance with certain aspects of the present disclosure. At 702, CQI for a first call with a first subscriber identity may be reported (CQI #1). As noted at 703, the Node B 108 may use the first call CQI to determine scheduling information (e.g., MCS) for a second call with a second subscriber identity. At 704, the scheduling information for the second call with the second subscriber identity may be transmitted, for example, on a HS-SCCH. At 706, CQI for the second call with the second subscriber identity may be reported (CQI #2). As noted at 707, the Node B 108 may use the second call CQI to determine subsequent scheduling information for the first call with the first subscriber identity. At 708, the subsequent scheduling information for the first call with the first subscriber identity may be transmitted.

For the sharing of CQI information from multiple HSDPA calls, the network should know that these calls belong to the same UE and, therefore, that the CQI information may be shared. For some embodiments, the information of the IMSI and physical UE ID, such as IMEI (International Mobile Equipment Identity) association, may be included in the home location register (HLR). Upon registration or call setup, this information may be forwarded to the TD-SCDMA network to indicate that the multiple HSDPA calls belong to the same UE.

The proposed disclosure may allow CQI reporting more frequently and timely in HSDPA operation for a UE with multiple USIMs.

Several aspects of a telecommunications system has been presented with reference to a TD-SCDMA system. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for wireless communication, comprising:
reporting channel quality information (CQI) for a first call with a first subscriber identity; and
receiving scheduling information for at least the first call with the first subscriber identity and a second call with a second subscriber identity, wherein the scheduling information for both the first and second calls are based on the CQI reported for the first call.

2. The method of claim 1, further comprising:
receiving a first data transmission during the second call with the second subscriber identity, wherein one or more parameters of the first data transmission are dependent on the CQI reported for the first call.

3. The method of claim 2, further comprising:
reporting CQI for the second call with the second subscriber identity; and
receiving a second data transmission during the second call, wherein one or more parameters of the second data transmission are dependent on the CQI reported for the second call.

4. The method of claim 1, further comprising:
reporting CQI for the second call with the second subscriber identity; and
receiving subsequent scheduling information for at least the first call with the first subscriber identity and the second call with the second subscriber identity, wherein the scheduling information for both the first and second calls are based on the CQI reported for the second call.

5. The method of claim 3, wherein the one or more parameters of the second data transmission comprise a modulation and coding scheme.

6. An apparatus for wireless communication, comprising:
means for reporting channel quality information (CQI) for a first call with a first subscriber identity; and
means for receiving scheduling information for at least the first call with the first subscriber identity and a second call with a second subscriber identity, wherein the scheduling information for both the first and second calls are based on the CQI reported for the first call.

7. The apparatus of claim 6, further comprising:
means for receiving a first data transmission during the second call with the second subscriber identity, wherein one or more parameters of the first data transmission are dependent on the CQI reported for the first call.

8. The apparatus of claim 7, further comprising:
means for reporting CQI for the second call with the second subscriber identity; and
means for receiving a second data transmission during the second call, wherein one or more parameters of the second data transmission are dependent on the CQI reported for the second call.

9. The apparatus of claim 6, further comprising:
means for reporting CQI for the second call with the second subscriber identity; and
means for receiving subsequent scheduling information for at least the first call with the first subscriber identity and the second call with the second subscriber identity, wherein the scheduling information for both the first and second calls are based on the CQI reported for the second call.

10. The apparatus of claim 8, wherein the one or more parameters of the second data transmission comprise a modulation and coding scheme.

11. An apparatus for wireless communication, comprising:
at least one processor adapted to:
report channel quality information (CQI) for a first call with a first subscriber identity; and
receive scheduling information for at least the first call with the first subscriber identity and a second call with a second subscriber identity, wherein the scheduling information for both the first and second calls are based on the CQI reported for the first call; and
a memory coupled to the at least one processor.

12. The apparatus of claim 11, wherein the at least one processor is adapted to:
receive a first data transmission during the second call with the second subscriber identity, wherein one or more parameters of the first data transmission are dependent on the CQI reported for the first call.

13. The apparatus of claim 12, wherein the at least one processor is adapted to:
report CQI for the second call with the second subscriber identity; and
receive a second data transmission during the second call, wherein one or more parameters of the second data transmission are dependent on the CQI reported for the second call.

14. The apparatus of claim 11, wherein the at least one processor is adapted to:
report CQI for the second call with the second subscriber identity; and
receive subsequent scheduling information for at least the first call with the first subscriber identity and the second call with the second subscriber identity, wherein the scheduling information for both the first and second calls are based on the CQI reported for the second call.

15. The apparatus of claim 13, wherein the one or more parameters of the second data transmission comprise a modulation and coding scheme.

16. A computer-program product, comprising:
a computer-readable medium comprising code for:
reporting channel quality information (CQI) for a first call with a first subscriber identity; and
receiving scheduling information for at least the first call with the first subscriber identity and a second call with a second subscriber identity, wherein the scheduling information for both the first and second calls are based on the CQI reported for the first call.

17. The computer-program product of claim 16, further comprising code for:
receiving a first data transmission during the second call with the second subscriber identity, wherein one or more parameters of the first data transmission are dependent on the CQI reported for the first call.

18. The computer-program product of claim 17, further comprising code for:
reporting CQI for the second call with the second subscriber identity; and
receiving a second data transmission during the second call, wherein one or more parameters of the second data transmission are dependent on the CQI reported for the second call.

19. The computer-program product of claim 16, further comprising code for:
reporting CQI for the second call with the second subscriber identity; and
receiving subsequent scheduling information for at least the first call with the first subscriber identity and the second call with the second subscriber identity, wherein the scheduling information for both the first and second calls are based on the CQI reported for the second call.

20. The computer-program product of claim 18, wherein the one or more parameters of the second data transmission comprise a modulation and coding scheme.

21. A method for wireless communication, comprising:
receiving channel quality information (CQI) reported for a first call with a first subscriber identity of a user equipment (UE); and
transmitting a first data transmission to the UE during a second call with a second subscriber identity of the UE, wherein one or more parameters of the first data transmission are dependent on the CQI reported for the first call.

22. The method of claim 21, further comprising:
receiving CQI reported for the second call with the second subscriber identity; and
transmitting a second data transmission to the UE during the second call, wherein one or more parameters of the second data transmission are dependent on the CQI reported for the second call.

23. The method of claim 21, wherein the one or more parameters of the first data transmission comprise scheduling information for at least the first call with the first subscriber identity and the second call with the second subscriber identity.

24. The method of claim 21, wherein the one or more parameters of the first data transmission comprise a modulation and coding scheme.

25. An apparatus for wireless communication, comprising:
means for receiving channel quality information (CQI) reported for a first call with a first subscriber identity of a user equipment (UE); and
means for transmitting a first data transmission to the UE during a second call with a second subscriber identity of the UE, wherein one or more parameters of the first data transmission are dependent on the CQI reported for the first call.

26. The apparatus of claim 25, further comprising:
means for receiving CQI reported for the second call with the second subscriber identity; and
means for transmitting a second data transmission to the UE during the second call, wherein one or more parameters of the second data transmission are dependent on the CQI reported for the second call.

27. The apparatus of claim 25, wherein the one or more parameters of the first data transmission comprise scheduling information for at least the first call with the first subscriber identity and the second call with the second subscriber identity.

28. The apparatus of claim 25, wherein the one or more parameters of the first data transmission comprise a modulation and coding scheme.

29. An apparatus for wireless communication, comprising:
at least one processor adapted to:
receive channel quality information (CQI) reported for a first call with a first subscriber identity of a user equipment (UE); and
transmit a first data transmission to the UE during a second call with a second subscriber identity of the UE, wherein one or more parameters of the first data transmission are dependent on the CQI reported for the first call; and
a memory coupled to the at least one processor.

30. The apparatus of claim 29, wherein the at least one processor is adapted to:
receive CQI reported for the second call with the second subscriber identity; and
transmit a second data transmission to the UE during the second call, wherein one or more parameters of the second data transmission are dependent on the CQI reported for the second call.

31. The apparatus of claim 29, wherein the one or more parameters of the first data transmission comprise scheduling information for at least the first call with the first subscriber identity and the second call with the second subscriber identity.

32. The apparatus of claim 29, wherein the one or more parameters of the first data transmission comprise a modulation and coding scheme.

33. A computer-program product, comprising:
a computer-readable medium comprising code for:
receiving channel quality information (CQI) reported for a first call with a first subscriber identity of a user equipment (UE); and
transmitting a first data transmission to the UE during a second call with a second subscriber identity of the UE, wherein one or more parameters of the first data transmission are dependent on the CQI reported for the first call.

34. The computer-program product of claim 33, further comprising code for:
receiving CQI reported for the second call with the second subscriber identity; and
transmitting a second data transmission to the UE during the second call, wherein one or more parameters of the second data transmission are dependent on the CQI reported for the second call.

35. The computer-program product of claim 33, wherein the one or more parameters of the first data transmission comprise scheduling information for at least the first call with the first subscriber identity and the second call with the second subscriber identity.

36. The computer-program product of claim 33, wherein the one or more parameters of the first data transmission comprise a modulation and coding scheme.
